(19) United States
(12) Patent Application Publication
(10) Pub. No.: US 2024/0211296 A1
(43) Pub. Date: Jun. 27, 2024

(54) CONTAINER-BASED HIGH AVAILABILITY BIG DATA FRAMEWORK SYSTEM AND OPERATING METHOD THEREOF

(71) Applicant: Korea Electronics Technology Institute, Seongnam-si (KR)

(72) Inventors: Jaekyu Lee, Yongin-si (KR); Sang Yub Lee, Yongin-si (KR); Inpyo Cho, Yongin-si (KR)

(21) Appl. No.: 18/394,242

(22) Filed: Dec. 22, 2023

(30) Foreign Application Priority Data
Dec. 27, 2022 (KR) 10-2022-0186416

(51) Int. Cl. G06F 9/455; G06F 16/23; G06F 16/25

(52) U.S. Cl. CPC G06F 9/45558; G06F 16/2365; G06F 16/258; G06F 2009/45591

(57) ABSTRACT

Proposed is a container-based high availability big data framework system. The system may include an external server configured to provide structured data. The system may also include a data collection server constructed based on a docker container environment and configured to collect structured data by requesting the structured data from the external server at a predetermined time interval. The system may further include a monitoring server configured to execute a new docker image by generating a trigger when detecting the occurrence of an error while the structured data are collected.

### CROSS-REFERENCE TO RELATED APPLICATION

This application claims priority to and the benefit of Korean Patent Application No. 10-2022-0186416, filed on Dec. 27, 2022, the disclosure of which is incorporated herein by reference in its entirety.

### BACKGROUND

### Technical Field

The present disclosure relates to a container-based high availability big data framework system and an operating method thereof.

### Description of the Related Technology

A docker container includes all libraries necessary for the execution of software, such as a code, runtime, a system tool, and a system library, in one (container) file system. Such a container technology guarantees that software is always identically executed regardless of a software execution environment.

### SUMMARY

One aspect is a container-based high availability big data framework system that can maximize the availability of a server by constructing a database server by using the docker container technology and dualizing a container that constitutes the database server, and an operating method thereof.

Another aspect is a container-based high availability big data framework system that may include an external server configured to provide structured data, a data collection server constructed based on a docker container environment and configured to collect structured data by requesting the structured data from the external server at a predetermined time interval, and a monitoring server configured to execute a new docker image by generating a trigger when detecting the occurrence of an error while the structured data are collected.

In some embodiments of the present disclosure, the data collection server may recover a docker image stopped by an error while processing data requested as the new docker image is executed by the monitoring server.

In some embodiments of the present disclosure, the data collection server may periodically collect structured data that are generated from a renewable energy generation complex by using a REST API and store the structured data in a database that is being executed as a docker container.

In some embodiments of the present disclosure, the external server may provide unstructured data to the data collection server. The data collection server may store the unstructured data in a file transfer protocol (FTP).

In some embodiments of the present disclosure, the external server may convert the unstructured data into a general-purpose execution file by using a cx_Freeze library.

Furthermore, a method of operating a container-based high availability big data framework system according to a second aspect of the present disclosure may include requesting structured data from an external server at a predetermined time, storing the structured data provided by the external server in a database that has been constructed based on a docker container environment, detecting the occurrence of an error while collecting the structured data, and executing a new docker image by generating a trigger when detecting the occurrence of the error.

In some embodiments of the present disclosure, the executing of the new docker image by generating the trigger when detecting the occurrence of the error may include recovering a docker image stopped by an error while processing data requested as the new docker image is executed.

In some embodiments of the present disclosure, the method further may include requesting unstructured data from the external server at a predetermined time and storing the unstructured data provided by the external server in a file transfer protocol (FTP).

The external server may transmit the unstructured data by converting the unstructured data into a general-purpose execution file by using a cx_Freeze library.

In addition, another method or another system for implementing the present disclosure and a computer-readable recording medium on which a computer program for executing the method is recorded may be further provided.

According to the aforementioned embodiment of the present disclosure, the availability of a server can be maximized because databases are operated by containerizing the databases in a docker container and dualizing the containerized databases.

Furthermore, there is an advantage in that a big data framework system can be implemented in a lightweight and low-cost way compared to a virtualization system at an operating system level because the big data framework system is based on the container virtualization technology not virtualization at an operating system level.

Effects of the present disclosure are not limited to the aforementioned effects, and other effects not described above may be evidently understood by a person having ordinary knowledge in the art to which the present disclosure pertains from the following description.

### BRIEF DESCRIPTION OF THE DRAWINGS

FIG. 1 is a diagram for describing the existing big data platform structure.

FIG. 2 is a diagram for describing a container-based high availability big data framework system according to an embodiment of the present disclosure.

FIG. 3 is a diagram illustrating an example of a container-based high availability big data framework structure according to an embodiment of the present disclosure.

FIG. 4 is a diagram illustrating a process of collecting structured data in an embodiment of the present disclosure.

FIG. 5 is a diagram illustrating a process of collecting unstructured data in an embodiment of the present disclosure.

FIG. 6 is a diagram for describing hardware components of the container-based high availability big data framework system.

FIG. 7 is a flowchart of an operating method of the container-based high availability big data framework system according to an embodiment of the present disclosure.

### DETAILED DESCRIPTION

A docker has an advantage in that the docker can be operated in a very lightweight way because the docker additionally provides an abstract and automation layer for virtualization at an operating system level in Linux and does not virtualize the operating system compared to the existing virtualization technology.

There is a need for a technology that is related to a big data framework structure for efficiently collecting renewable energy-related structured and unstructured data, such as sunlight and wind power, based on such a docker container technology, and a method of operating the same.

Advantages and characteristics of the present disclosure and a method for achieving the advantages and characteristics will become apparent from the embodiments described in detail later in conjunction with the accompanying drawings. However, the present disclosure is not limited to embodiments disclosed hereinafter, but may be implemented in various different forms. The embodiments are merely provided to complete the present disclosure and to fully notify a person having ordinary knowledge in the art to which the present disclosure pertains of the category of the present disclosure. The present disclosure is merely defined by the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other elements in addition to a mentioned element. Throughout the specification, the same reference numerals denote the same elements. “And/or” includes each of mentioned elements and all combinations of one or more of mentioned elements. Although the terms “first”, “second”, etc. are used to describe various components, these elements are not limited by these terms. These terms are merely used to distinguish between one element and another element. Accordingly, a first element mentioned hereinafter may be a second element within the technical spirit of the present disclosure.

All terms (including technical and scientific terms) used in this specification, unless defined otherwise, will be used as meanings which may be understood in common by a person having ordinary knowledge in the art to which the present disclosure pertains. Furthermore, terms defined in commonly used dictionaries are not construed as being ideal or excessively formal unless specially defined otherwise.

Hereinafter, in order to help understanding of those skilled in the art, a proposed background of the present disclosure is first described and an embodiment of the present disclosure is then described in detail.

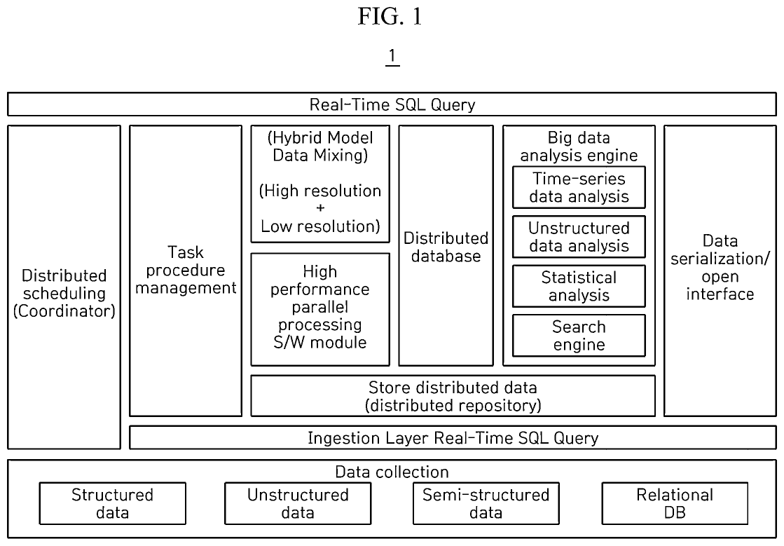

FIG. 1 is a diagram for describing the existing big data platform structure 1.

In order to efficiently construct a big data system, it is very important to efficiently collect data without missing data. Accordingly, it is necessarily required to construct a high availability big data platform in order to collect data consecutively and faultlessly.

Referring to FIG. 1, the existing big data platform structure 1 includes software modules that are necessary for the collection, accumulation, and analysis of data. In this case, each of the software modules is directly installed in server hardware or installed through virtualization at an operating system level.

Databases that are installed in a server platform based on hardware can increase the availability of a server through the dualization of a hardware device. Such a method has a problem in that it requires a lot of costs in constructing a database server platform.

Furthermore, if the database server platform is constructed through the virtualization at the operating system level, less costs are required compared to the dualization of hardware. However, there is a problem in that high computing power is required to operate multiple virtualized operating systems.

In contrast, in a container-based high availability big data framework system and an operating method thereof according to embodiments of the present disclosure, a docker container is used to construct a high availability big data platform. Unlike the existing virtualization system, the docker container is a technology in which processes are isolated. All types of software that are necessary to execute an application program, such as a code, a library, runtime, and a system tool, are included in the container.

Accordingly, an embodiment of the present disclosure has an advantage in that it is lightweight and can maximize the availability of a database itself compared to the existing system.

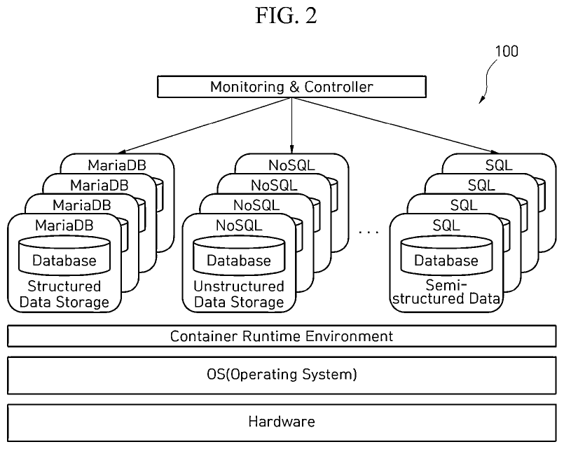

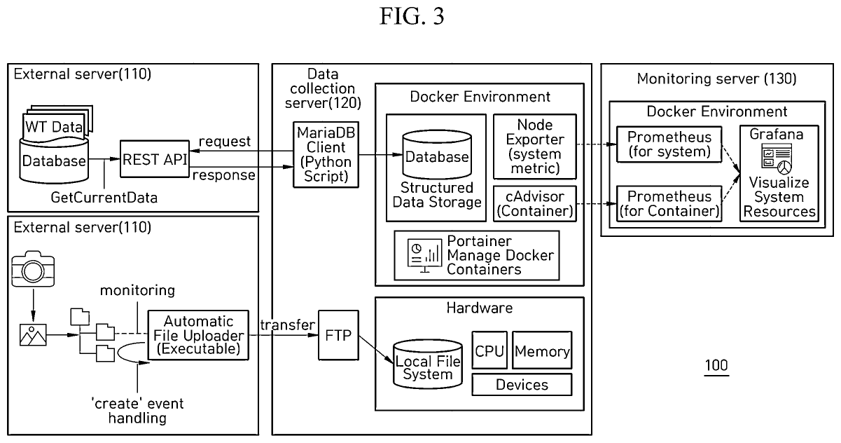

FIG. 2 is a diagram for describing a container-based high availability big data framework system 100 according to an embodiment of the present disclosure. FIG. 3 is a diagram illustrating an example of a container-based high availability big data framework structure according to an embodiment of the present disclosure.

In the container-based high availability big data framework system 100 according to an embodiment of the present disclosure, each of database (DB) platforms is containerized as a docker. The availability of a database is improved by dualizing a container module.

Specifically, the container-based high availability big data framework system according to an embodiment of the present disclosure includes at least one external server 110, a data collection server 120, and a monitoring server 130.

The external server 110 provides structured data to the data collection server 120.

The data collection server 120 is constructed based on a docker container environment, and collects and accumulates data by requesting structured data from the external server 110 at a predetermined time interval.

When detecting the occurrence of an error during the collection of the structured data, the monitoring server 130 executes a new docker image by generating a trigger.

In this case, while the new docker image is executed by the monitoring server 130 and requested data is processed, the data collection server 120 may perform a process of recovering a docker image stopped by the error. Furthermore, if a replaced database has been stopped due to the error, the data collection server 120 may replace the replaced database with another database.

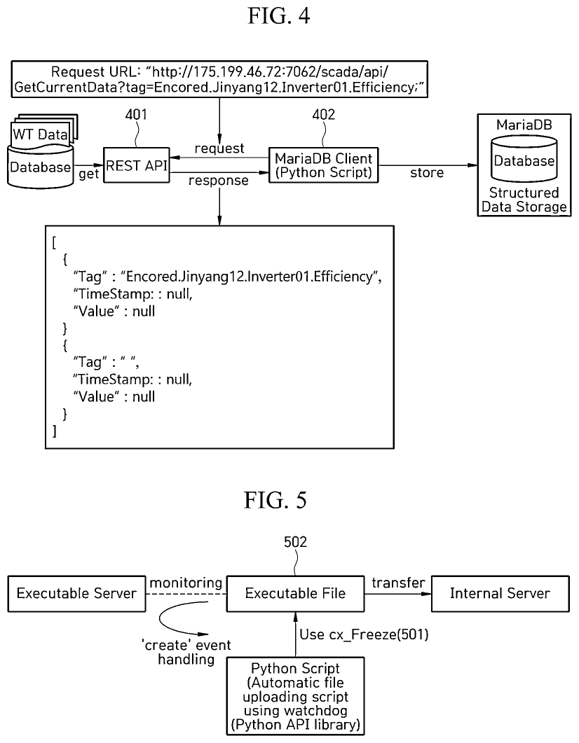

FIG. 4 is a diagram illustrating a process of collecting structured data in an embodiment of the present disclosure.

FIG. 4 illustrates an example in which an environment in which structured data collected by the external server 110 are loaded onto an internal repository has been constructed. The data collection server 120 may periodically collect structured data that are generated from a renewable energy generation complex by using a REST API 401, and may store the structured data in a database 402 that is being executed as a docker container. In this case, the database 402 that is being executed as a docker container may be MariaDB.

FIG. 5 is a diagram illustrating a process of collecting unstructured data in an embodiment of the present disclosure.

The external server 110 according to an embodiment of the present disclosure may provide unstructured data to the data collection server 120. For example, the unstructured data may be an image file that has been obtained by a camera. The unstructured data may be automatically uploaded onto a data collection server that is disposed at a remote place. Furthermore, the external server 110 may convert the unstructured data into a general-purpose execution file 502 by using a cx_Freeze library 501 so that a program can be driven even in an environment in which Python has not been installed.

The data collection server 120 may store the unstructured data in a file transfer protocol (FTP) server for collecting container-based unstructured data.

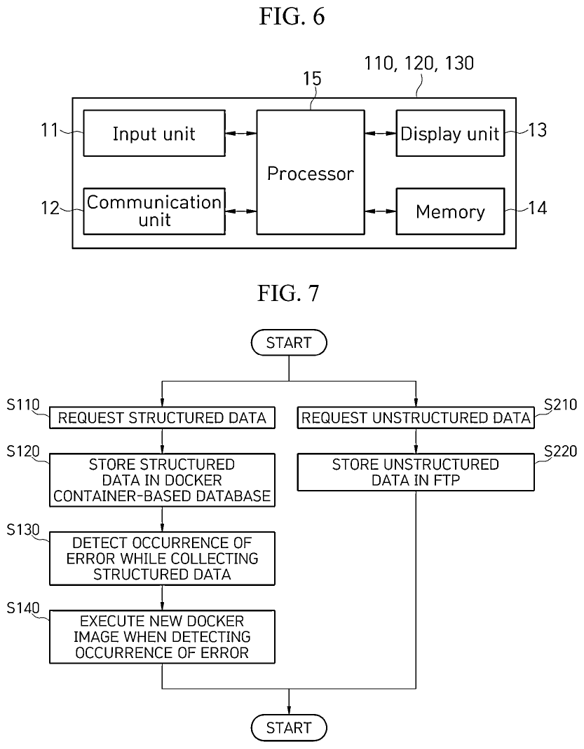

FIG. 6 is a diagram for describing hardware components of the container-based high availability big data framework system.

Each of the external server 110, the data collection server 120, and the monitoring server 130 according to an embodiment of the present disclosure includes an input unit 11, a communication unit 12, a display unit 13, memory 14, and a processor 15.

The input unit 11 generates input data in response to a user input to each server 100. The input unit 11 includes at least one input means. The input unit 11 may include a keyboard, a key pad, a dome switch, a touch panel, a touch key, a mouse, and a menu button.

The communication unit 12 transmits and receives data between the external server 110, the data collection server 120, and the monitoring server 130 or performs communication between internal components of each server. The communication unit 12 may include both a wired communication module and a wireless communication module. The wired communication module may be implemented by using a power line communication device, a telephone line communication device, cable home (MoCA), Ethernet, IEEE1294, an integrated wired home network, or an RS-485 controller. Furthermore, the wireless communication module may be constructed in the form of a module for implementing a function, such as a wireless LAN (WLAN), Bluetooth, a HDR WPAN, UWB, ZigBee, Impulse Radio, a 60 GHz WPAN, Binary-CDMA, a wireless USB technology, a wireless HDMI technology, 5^{th} generation (5G) communication, long term evolution-advanced (LTE-A), long term evolution (LTE), or wireless fidelity (Wi-Fi).

The display unit 13 displays display data according to an operation of each of the servers 110, 120, and 130. The display unit 13 includes a liquid crystal display (LCD), a light emitting diode (LED) display, an organic LED (OLED) display, a micro electro mechanical systems (MEMS) display, and an electronic paper display. The display unit 13 may be implemented as a touch screen by being coupled with the input unit 11.

The memory 14 stores programs for collecting and managing structured and unstructured data based on the docker container. In this case, the memory 14 collectively refers to nonvolatile storage that continue to retain information stored therein although power is not supplied thereto and volatile storage. For example, the memory 14 may include NAND flash memory, such as a compact flash (CF) card, a secure digital (SD) card, a memory stick, a solid-state drive (SSD), and a micro SD card, magnetic computer storage, such as a hard disk drive (HDD), and optical disc drives, such as CD-ROM and DVD-ROM.

The processor 15 may control at least another component (e.g., a hardware or software component) of each of the servers 110, 120, and 130 by executing software, such as a program, and may perform various data processing or operations.

Hereinafter, an operating method that is performed by the container-based high availability big data framework system 100 according to an embodiment of the present disclosure is described with reference to FIG. 8.

FIG. 7 is a flowchart of an operating method of the container-based high availability big data framework system according to an embodiment of the present disclosure.

First, the data collection server requests structured data from the external server at a predetermined time (S110).

Next, the data collection server stores the structured data provided by the external server in a database that has been constructed based on a docker container environment (S120).

Next, the monitoring server detects the occurrence of an error while the structured data are collected (S130), and executes a new docker image by generating a trigger when detecting the occurrence of the error (S140).

Furthermore, according to an embodiment of the present disclosure, the data collection server may request unstructured data from the external server at a predetermined time (S210), and may store the unstructured data provided by the external server in a file transfer protocol (FTP) (S220).

In this case, the external server may transmit the unstructured data by converting the unstructured data into a general-purpose execution file by using the cx_Freeze library.

In the aforementioned description, each of steps S110 to S220 may be further divided into additional steps or the steps may be combined into smaller steps depending on an implementation example of the present disclosure. Furthermore, some of the steps may be omitted, if necessary, and the sequence of the steps may be changed. Furthermore, although contents are omitted, the contents described with reference to FIGS. 2 to 6 may also be applied to the contents described with reference to FIG. 7.

The aforementioned embodiment of the present disclosure may be implemented in the form of a program (or application) in order to be executed by being combined with a server, that is, hardware, and may be stored in a medium.

The aforementioned program may include a code coded in a computer language, such as C, C++, JAVA, python, or a machine language which is readable by a processor (CPU) of a computer through a device interface of the computer in order for the computer to read the program and execute the methods implemented as the program. Such a code may include a functional code related to a function, etc. that defines functions necessary to execute the methods, and may include an execution procedure-related control code necessary for the processor of the computer to execute the functions according to a given procedure. Furthermore, such a code may further include a memory reference-related code indicating at which location (address number) of the memory inside or outside the computer additional information or media necessary for the processor of the computer to execute the functions needs to be referred. Furthermore, if the processor of the computer requires communication with any other remote computer or server in order to execute the functions, the code may further include a communication-related code indicating how the processor communicates with the any other remote computer or server by using a communication module of the computer and which information or media needs to be transmitted and received upon communication.

The stored medium means a medium, which semi-permanently stores data and is readable by a device, not a medium storing data for a short moment like a register, cache, or a memory. Specifically, examples of the stored medium include a ROM, a RAM, a CD-ROM, a magnetic tape, a floppy disk, optical data storage, etc., but the present disclosure is not limited thereto. That is, the program may be stored in various recording media in various servers which may be accessed by a computer or various recording media in a computer of a user. Furthermore, the medium may be distributed to computer systems connected over a network, and a code readable by a computer in a distributed way may be stored in the medium.

The steps of the method or algorithm described in relation to the embodiments of the present disclosure may be directly implemented as hardware, may be implemented as a software module executed by hardware, or may be implemented by a combination of them. The software module may reside in random access memory (RAM), read only memory (ROM), erasable programmable ROM (EPROM), electrically erasable programmable ROM (EEPROM), flash memory, a hard disk, a detachable disk, CD-ROM, or a computer-readable medium having a given form, which is well known in the field to which the present disclosure pertains.

Although the embodiments of the present disclosure have been described with reference to the accompanying drawings, a person of ordinary knowledge in the art to which the present disclosure pertains may understand that the present disclosure may be implemented in other detailed forms without changing the technical spirit or essential characteristics of the present disclosure. Accordingly, it is to be understood that the aforementioned embodiments are only illustrative, but are not limitative in all aspects.

What is claimed is:

1. A container-based high availability big data framework system comprising:
an external server configured to provide structured data;
a data collection server constructed based on a docker container environment and configured to collect structured data by requesting the structured data from the external server at a predetermined time interval; and
a monitoring server configured to execute a new docker image by generating a trigger when detecting an occurrence of an error while the structured data are collected.

2. The container-based high availability big data framework system of claim 1, wherein the data collection server is configured to recover a docker image stopped by an error while processing data requested as the new docker image is executed by the monitoring server.

3. The container-based high availability big data framework system of claim 1, wherein the data collection server is configured to periodically collect structured data that are generated from a renewable energy generation complex by using a representational state transfer (REST) application programming interface (API) and store the structured data in a database that is being executed as a docker container.

4. The container-based high availability big data framework system of claim 1, wherein:
the external server is configured to provide unstructured data to the data collection server, and
the data collection server is configured to store the unstructured data in a file transfer protocol (FTP).

5. The container-based high availability big data framework system of claim 4, wherein the external server is configured to convert the unstructured data into a general- purpose execution file by using a cx_Freeze library.

6. A method of operating a container-based high availability big data framework system, the method comprising:
requesting structured data from an external server at a predetermined time;
storing the structured data provided by the external server in a database that has been constructed based on a docker container environment;
detecting an occurrence of an error while collecting the structured data; and
executing a new docker image by generating a trigger when detecting the occurrence of the error.

7. The method of claim 6, wherein the executing of the new docker image by generating the trigger when detecting the occurrence of the error comprises recovering a docker image stopped by an error while processing data requested as the new docker image is executed.

8. The method of claim 6, further comprising:
requesting unstructured data from the external server at a predetermined time; and
storing the unstructured data provided by the external server in a file transfer protocol (FTP),
wherein the external server transmits the unstructured data by converting the unstructured data into a general-purpose execution file by using a cx_Freeze library.
